(19) United States
(12) Patent Application Publication
(10) Pub. No.: US 2019/0085227 A1
(43) Pub. Date: Mar. 21, 2019

(54) ELECTRICAL INSULATING MATERIAL FOR HIGH VOLTAGE EQUIPMENT

(71) Applicant: Hitachi, Ltd., Tokyo (JP)

(72) Inventors: Kinya KOBAYASHI, Tokyo (JP); Atsushi OOTAKE, Tokyo (JP)

(21) Appl. No.: 15/779,552

(22) PCT Filed: Dec. 7, 2015
(86) PCT No.: PCT/JP2015/084310

§ 371 Date: May 29, 2018

(51) Int. Cl. C09K 5/14; C08K 3/36; C08K 3/22; C08K 9/04; C08K 7/18; C08L 63/00; C08G 59/00; H01B 3/40; H01B 3/44

(52) U.S. Cl. CPC C09K 5/14; H02B 13/02; C08K 3/22; C08K 9/04; C08K 7/18; C08L 63/00; C08G 59/00; H01B 3/40; H01B 3/441; C08K 2003/2227; C08K 2201/011; C08K 2201/003; C08K 2201/001; C08L 2203/20; C08K 3/36

(57) ABSTRACT

The present invention provides an electrical insulating material for high voltage equipment which suppresses precipitation of additive materials, while achieving electrical and mechanical properties equal to or higher than those of the conventional ones. An electrical insulating material for high voltage equipment according to an embodiment of the present invention includes: a resin (3); and additive materials (1, 2) and fine particles (4) dispersed in the resin (3), wherein the fine particles (4) have the same main skeleton as the additive materials (1, 2), and have an average particle diameter of 1-200 nm, and some of atoms forming the main skeleton are bonded to an organic group and an inorganic group, and are arranged around the additive materials (1, 2).

### TECHNICAL FIELD

The present invention relates to an electrical insulating material for high voltage equipment.

### BACKGROUND ART

Recently, for the purpose of miniaturization and higher reliability of electrical equipment utilizing an electrical insulating material for high voltage equipment, a method of mixing various additives in a resin has been taken. In particular, for higher thermal conductivity, lower coefficient of linear expansion, improved fracture toughness, improved insulation lifetime, and the like of a resin, various kinds of functional materials such as high thermal conductive materials, low linear expansion materials, elastomers and nanoparticles are added.

PTL 1 discloses a resin material which is a cured product including fine particles and a resin component, wherein the resin component is a bisphenol A type epoxy resin having a hydrophilic group in a branched chain, and the fine particles are an inorganic compound, an organic compound or an organic and inorganic composite, have an organic hydrophobic group on the surface, have a particle diameter of 200 nm or less, and are contained at 2.5-6% by mass of the resin component, an uncured composition including the fine particles and the resin has thixotropy, and the aggregate of the fine particles formed in the resin composition has a dendrite-like structure extended in a three-dimensional direction as a plurality of linear aggregates. PTL 1 discloses that by the configuration, the hydrophobic fine particles can be dispersed within a hydrophilic resin without agglomerating, and also, a linear structure or a dendrite-like structure of the fine particles can be formed within the resin to improve the strength of the resin, thereby improving the mechanical strength and the voltage resistance of the resin material.

### CITATION LIST

### Patent Literature

PTL 1: JP 5250003 B2

### SUMMARY OF INVENTION

### Technical Problem

In general, in an insulating material for high voltage electrical equipment, various functional additive materials (fillers) such as a high thermal conductive material, a low linear expansion material and elastomers are mixed, for the purpose of higher thermal conductivity, lower linear expansion and improved toughness of a resin. In this case, as the proportion of the additive materials in the resin is increased, the additive materials are likely to be aggregated and precipitated in the uncured resin. When the additive materials are precipitated in the resin, means for suppressing precipitation of the additive materials, for example by raising the temperature of the means of transportation of the resin are needed, thereby increasing the facility and maintenance management costs.

Meanwhile, in PTL 1, fine particles (hydrophobic nanoparticles) are added to improve the dispersibility of the fine particles in the resin to suppress the aggregation of the fine particles, while forming the dendrite structure of the fine particles in the resin, thereby allowing fracture toughness and dielectric breakdown lifetime of the resin to be improved. However, in PTL 1, the prevention of aggregation of the fine particles in the resin is reviewed, but suppressing precipitation of the additive materials is not described.

In view of the above circumstances, an aspect of the present invention provides an electrical insulating material for high voltage equipment which suppresses precipitation of additive materials included in a resin, while achieving electrical and mechanical properties equal to or higher than those of the conventional materials.

### Solution to Problem

In order to solve the above issue, the present invention provides an electrical insulating material for high voltage equipment including: a resin; and additive materials and fine particles dispersed in the resin, wherein the fine particles have the same main skeleton as the additive materials, and have an average particle diameter of 1-200 nm, and some of atoms forming the main skeleton are bonded to an organic group and an inorganic group, and are arranged around the additive materials.

### Advantageous Effects of Invention

According to the present invention, an electrical insulating material for high voltage equipment which suppresses precipitation of additive materials, while achieving electrical and mechanical properties equal to or higher than those of the conventional materials can be provided.

The subject, configuration and effect other than the above will be apparent from the following description of the exemplary embodiments.

### BRIEF DESCRIPTION OF DRAWINGS

FIG. 1 is a cross-sectional view schematically representing an example of the electrical insulating material for high voltage equipment according to the present invention.

FIG. 2 is a chemical structure diagram schematically representing an example of the fine particles of FIG. 1.

FIG. 3 is a schematic diagram partially enlarging the additive material 1 and the fine particle 4 in FIG. 1.

FIG. 4 is a graph representing a relationship between the precipitation amount of the additive materials 1 and the average particle diameter of the fine particles 4.

FIG. 5 is a graph representing a relationship between the dielectric breakdown lifetime of the resin 10 and the average particle diameter of the fine particles 4.

FIG. 6 is a graph representing the relationship among the dielectric breakdown lifetime of the resin 10, the precipitation amount of the additive material 1, and the ratio of the organic group and the inorganic group possessed by the fine particles 4.

FIG. 7 is a drawing schematically representing the first example of the additive material (dry crushed silica).

FIG. 8 is a drawing schematically representing the second example of the additive material (wet crushed silica).

FIG. 9 is a schematic cross-sectional view representing the first example of the high voltage equipment (switch gear).

FIG. 10 is a schematic cross-sectional view representing the second example of the high voltage equipment (mold transformer).

### DESCRIPTION OF EMBODIMENTS

Hereinafter, exemplary embodiments of the present invention will be described with reference to the accompanying drawings.

### [Electrical Insulating Material for High Voltage Equipment]

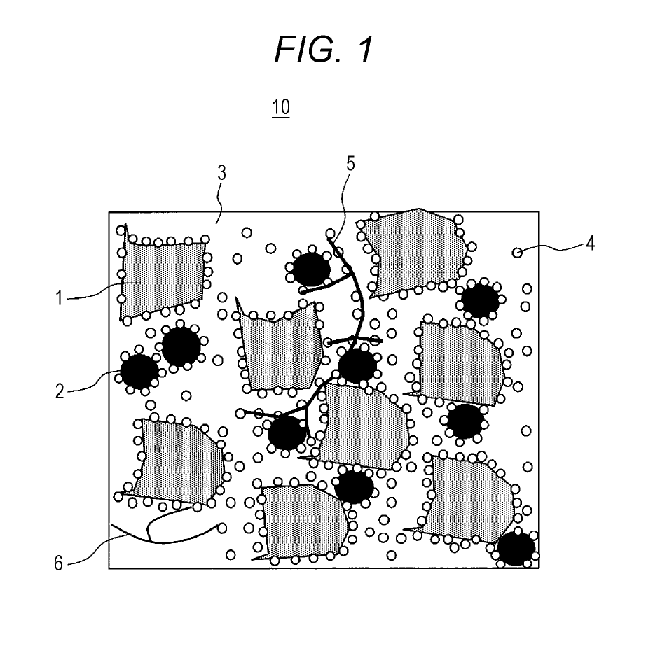

FIG. 1 is a cross-sectional view schematically representing an example of the electrical insulating material for high voltage equipment according to the present invention (hereinafter, simply referred to as “insulating material”). As illustrated in FIG. 1, the electrical insulating material for high voltage equipment 10 according to the present invention includes a resin 3 which becomes a matrix, additive materials 1 and 2 dispersed in the resin 3, and fine particles 4. In FIG. 1, as the additive material, crushed silica (SiO₂) 1 as a thermal conductive material, and fused spherical silica 2 as a low linear expansion material are used. In addition, the fine particles 4 have the same main skeleton as the additive materials 1 and 2, have an average particle diameter of 200 nm or less, have an organic group and an inorganic group, and are arranged around the additive materials 1 and 2. The fine particles 4 are arranged around the additive materials 1 and 2 by having the same main skeleton as the additive materials 1 and 2, thereby suppressing precipitation (settling) of the additive materials 1 and 2. In addition, the fine particles 4 are dispersed in the shape of a dendrite structure 5 in a resin 3 (forming a dendrite structure 5), thereby suppressing progress of cracks and electrical trees 6 of the resin 3, and improving the mechanical properties and electrical properties (fracture toughness and dielectric breakdown lifetime) of the resin to be equal to or higher than the conventional ones.

Further, in the present invention, “the electrical insulating material for high voltage equipment” refers to both a resin composition before curing the resin 3, and the cured product after curing the resin 3. That is, the electrical insulating material for high voltage equipment according to the present invention has the configuration represented by FIG. 1 before and after curing. For the cured product, the configuration represented by FIG. 1 can be confirmed by observing the cross-sectional scanning electron microscope (SEM) photograph. Hereinafter, each component of the electrical insulating material according to the present invention will be described in detail.

### (1) Fine Particles

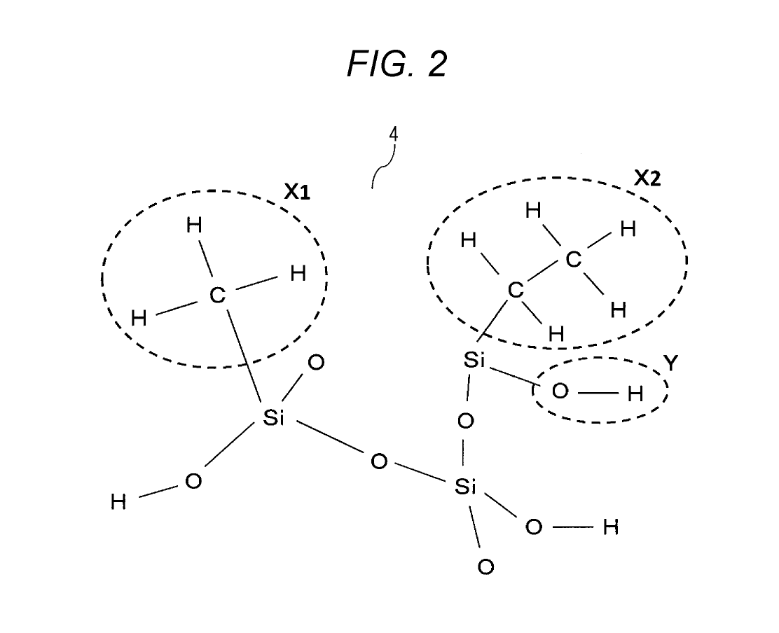

FIG. 2 is a chemical structure diagram schematically representing an example of the fine particles 4 of FIG. 1. FIG. 2 illustrates an example in which fine particles 4 (nanoparticles) are formed of silica. In FIG. 2, the main skeleton of the fine particles 4 (—Si—O—Si—) is formed of silica, and some of the Si atoms forming this main skeleton are bonded to at least one of an organic group (X1 (methyl group), X2 (ethyl group)) or an inorganic group (Y (OH group)). That is, at least a portion of oxygen (O) bonded to silicon (Si) forming the fine particles 4 is substituted by a substituent (organic group or inorganic group). Both the organic group and the inorganic group form the dendrite structure of the fine particles 4 in the resin 3, and improve the fracture toughness and the dielectric breakdown lifetime of the resin. Meanwhile, too many organic groups cause the viscosity of the resin 3 to be increased, making casting difficult. In addition, contrary to the organic group, too many inorganic groups cause the viscosity to be unduly lowered, making casting difficult. From this point of view, the ratio of the organic group is preferably 25-50% (25% or more and 50% or less), and the ratio of the inorganic group is preferably 50-75%, in the total mass of the organic and inorganic groups.

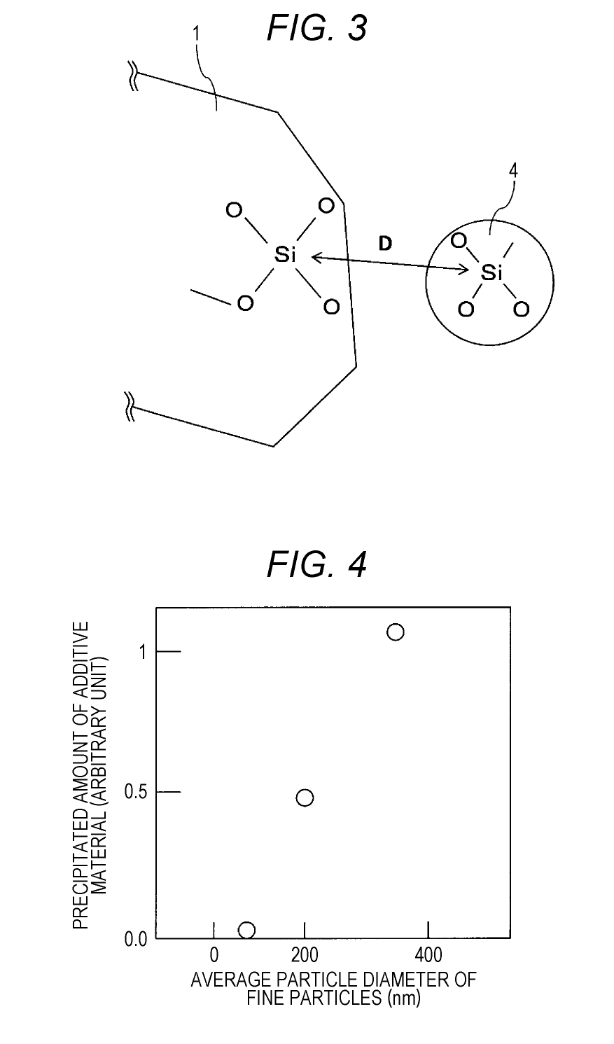

In addition, the fine particles 4 may contain at least one organic group and at least one inorganic group, respectively, and may contain two or more organic groups and two or more inorganic groups, respectively. FIG. 3 represents an example including two kinds of organic groups (X1, X2), and one kind of inorganic group (Y), but not limited thereto. The fine particles 4 having the organic group and the inorganic group can be confirmed by analysis by infrared absorption spectrometry (IR) or nuclear magnetic resonance (NMR).

It is preferred that the main skeleton of the fine particles 4 is formed of silica, alumina (Al₂O₃), boron nitride (BN), aluminum nitride (AlN) or a metal oxide. Some of silicon (Si) forming silica, aluminum (Al) forming alumina, boron (B) forming boron nitride, Al forming aluminum nitride, and a metal forming the metal oxide are bonded to at least one of the organic groups or inorganic groups. Among these, silica and alumina are more preferred, and silica is particularly preferred. Alumina has a structure in which planes having two-dimensional bonds are laminated, and the bond in a laminated direction is by Van der Waals force having relatively weak bonding force. Meanwhile, since silica has a three-dimensional strong bond, it can suppress progress of cracks and electrical trees 6, and further improve the mechanical and electrical properties of the resin 3.

It is preferred that the organic group includes carbon (C), oxygen (O), hydrogen (H) or nitrogen (N). Having a relatively low molecular weight is preferred in terms of suppression of viscosity increase, and also, a chain structure is more preferred than a cyclic structure. A hydrocarbon group having 2 to 5 carbon atoms is preferred. In particular, a methyl group (—CH₃) or an ethyl group (—CH₂CH₃) is preferred. As the inorganic group, a hydroxyl group (—OH), a boron nitride group (—BN), or an aluminum nitride group (—AlN) is preferred. Among these, AlN having high thermal conductivity is preferred.

FIG. 3 is a schematic diagram partially enlarging the additive material 1 and the fine particle 4 in FIG. 1. As shown in FIG. 1, the fine particles 4 are arranged around the additive material 1. The distance D between the Si atom forming the surface of the additive materials and 2 and the Si atom forming the fine particles 4 arranged around the additive materials 1 and 2 is 0.9-1.1 nm. In the present invention, when the distance D is within the range, it is expressed as being that “the fine particles 4 are arranged around the additive materials 1 and 2”. The distance D can be evaluated by X-ray diffraction (XRD) analysis.

In the following, the effect of the fine particles 4 will be described in detail. FIG. 4 is a graph representing a relationship between the precipitation amount of the additive material and the particle diameter of the fine particles 4. FIG. 4 represents the amount of the additive materials 1 and 2 precipitated in an epoxy resin, when adding 5% by mass of silica fine particles 4 containing Si to which both the organic group (—CH₃) and the inorganic group (—OH) of 50-400 nm are bonded (50% each), to the resin. The precipitation amount was evaluated from the weight of the precipitate from which the resin solvent is removed. In FIG. 4, the precipitation amount when not including the fine particles 4 is “1”. The samples in each plot of FIG. 4 are under the same conditions except for the average particle diameter. As shown in FIG. 4, as the particle diameter of the fine particles 4 is decreased, the precipitation of the additive materials is suppressed. This is caused by the following: (i) the fine particles 4 are arranged around the additive materials 1 and 2, and (ii) the fine particles 4 suppress the polymerization and precipitation of the additive materials 1 and 2 by Brownian motion, as in FIG. 1.

For the above (i), the fine particles 4 being arranged around the additive materials 1 and 2 are due to the main skeleton of both sides being identical (herein both are silica), as described above. In the case of silica, for example, Si having positive polarity and O having negative polarity forming the additive materials 1 and 2 and the fine particles 4 attract each other by Coulomb force, and are strongly bonded to each other in a hydrogen bond manner. In the case of other skeletons as described above, the fine particles are arranged around the additive materials 1 and 2 by the same operational effect. By arranging the particles 4 around the additive materials 1 and 2, the polymerization and precipitation of the additive materials 1 and 2 are suppressed.

For the above (ii), in the Brownian motion theory of particles in a solution, the diffusion coefficient (D) is proportional to temperature/(radius×viscosity), as shown in the following Equation 1:

D(diffusion coefficient)∝temperature/(radius×viscosity) Equation 1

Therefore, as the size (diameter) of the fine particles 4 is smaller, the diffusion coefficient is higher, from Equation 1, so that the diffusivity of the fine particles 4 is higher. This causes the polymerization and precipitation of the additive materials 1 and 2 to be suppressed.

As shown in FIG. 4, it is recognized that when the average particle diameter of the fine particles 4 is 200 nm or less, the precipitation amount of the additive materials 1 and 2 is decreased to 50% or less, as compared with the case of not adding the fine particles 4. Therefore, in the present invention, the average particle diameter of the fine particles 4 is 200 nm or less. By suppressing the precipitation of the additive materials 1 and 2, no facility for raising temperature is required when storing for a long time, thereby reducing the cost.

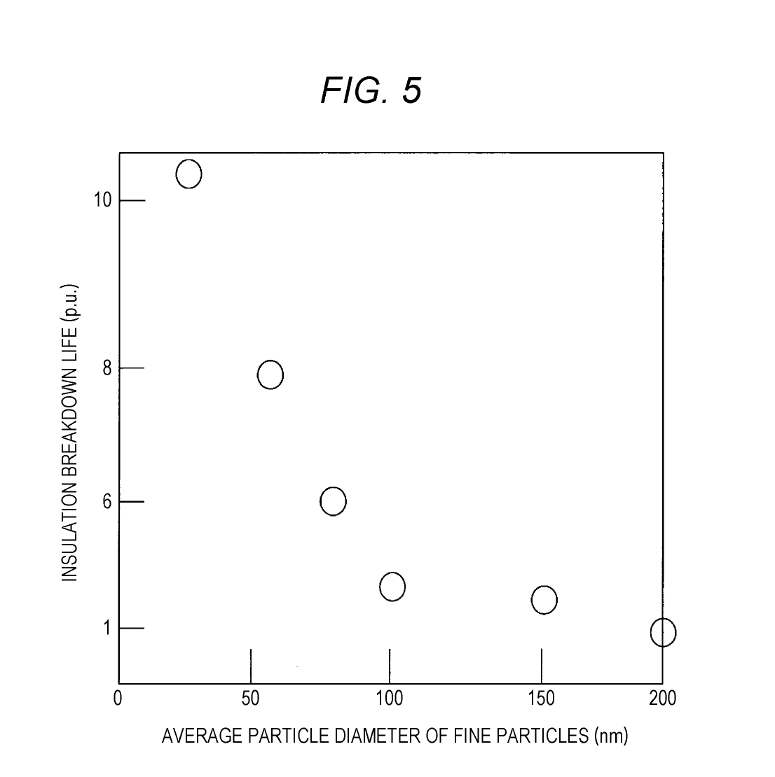

FIG. 5 is a graph representing a relationship between the dielectric breakdown lifetime of the insulating material 10 and the average particle diameter of the fine particle 4. It is the result of evaluating the dielectric breakdown lifetime of the resin, when adding 5% by mass of silica fine particles 4 containing silicon to which both the organic group (—CH₃) and the inorganic group (—OH) of 25-200 nm are bonded (50% each), to an epoxy resin. The samples in each plot of FIG. 5 are under the same conditions except for the average particle diameter. In FIG. 5, the dielectric breakdown lifetime when not including the fine particles 4 is “0”. As shown in FIG. 5, as the average particle diameter of the fine particles 4 is decreased, the dielectric breakdown lifetime is improved (prolonged). In addition, as a result of evaluating the fracture toughness of the sample having an average particle diameter of 200 nm in FIG. 5, the fracture toughness was increased by 25%, as compared with the sample not including the fine particles 4, and thus, improving mechanical properties was experimentally confirmed.

From the above results, the average particle diameter of 200 nm or less is preferred for suppressing precipitation of the additive materials and improving mechanical and electrical properties thereof. In addition, the average particle diameter of 1 nm or more is preferred, since when less than 1 nm, it is difficult to handle the particles.

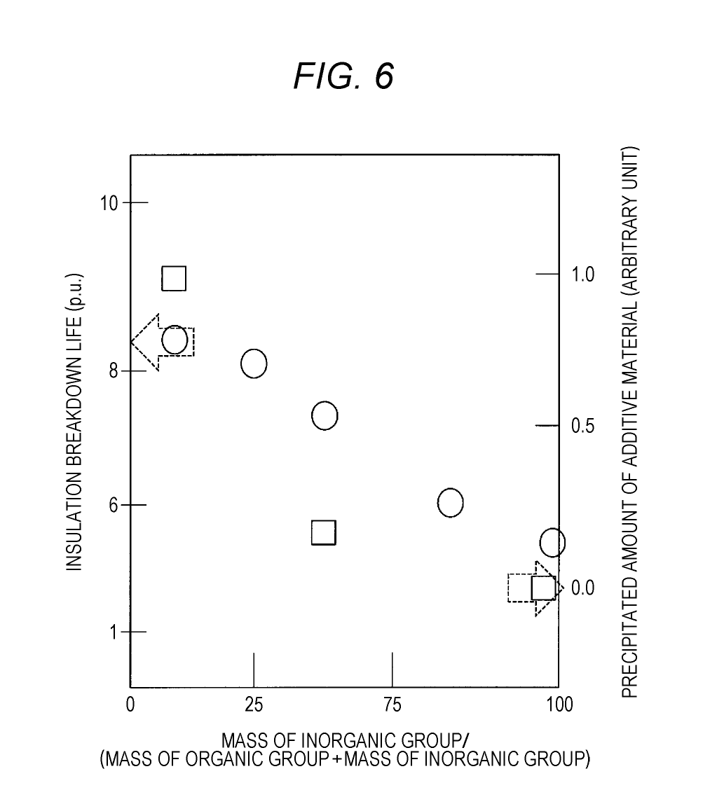

FIG. 6 is a graph representing the relationship among the dielectric breakdown lifetime of the insulating material 10, the precipitation amount of the additive material 1, and the ratio of the organic group (—CH₃) and the inorganic group (—OH) possessed by the fine particle 4. It is a drawing representing the results when adding silica fine particles 4 of 200 nm to an epoxy resin. The samples in each plot of FIG. 6 are under the same conditions except for the ratios of the inorganic group and the organic group. As shown in FIG. 6, as the ratio of the organic group is higher, the dielectric breakdown lifetime is improved. Meanwhile, the precipitation amount of the additive material can be suppressed by a higher ratio of the inorganic group. It is preferred that the ratio of the organic group is 25-50%, and the ratio of the inorganic group is 50-75%, considering also the viscosity of the resin.

It is preferred that the addition amount of the fine particles 4 is 0.1-5% by mass of the insulating material 10. When the amount is less than 0.1% by mass, the effect of adding the fine particles 4 (suppression of precipitation of the additive material and improvement of fracture toughness and dielectric breakdown lifetime) cannot be sufficiently obtained. In addition, it is not preferred that the amount is more than 5% by mass, since the viscosity is excessively increased.

Usually, since the nanoparticles (such as silica nanoparticles) increase the viscosity of the resin, it is not considered by a person skilled in the art that after adding the additive material formed of silica to the resin, silica nanoparticles are intentionally further added. The present invention is to add nanoparticles while balancing with the viscosity of the resin, and obtain the maximum effect (suppression of precipitation of the additive materials and improvement of electrical properties), and it has not been achieved in the prior art to obtain the effect, and thus, the present invention is a novel technique.

“The organic and inorganic composite” disclosed in PTL 1 described above is, for example, described as “such as an organic clay in which the surface of inorganic mineral such as mica is modified with an organic salt”, however, in the fine particles forming the insulating material of the present invention, some of the atoms forming the main skeleton are bonded to the organic group and the inorganic group, which is different from the case of having the organic group and the inorganic group only on the surface.

### (2) Additive Material

As described above, the additive materials 1 and 2 have the same main skeleton as the fine particles 4. Silica from which improved mechanical properties can be more expected by a three-dimensional structure, and Al₂O₃, BN, AlN or a metal oxide having high thermal conductivity is preferred. The specific materials may include crushed silica which is a high thermal conductive material increasing the thermal conductivity of the resin, and fused spherical silica which is a low linear expansion material decreasing residual thermal stress under a high temperature difference environment.

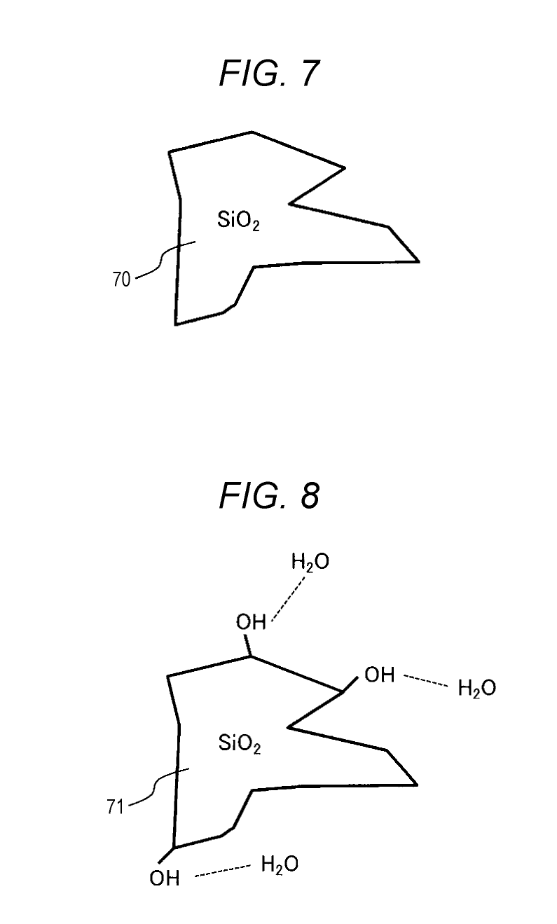

The crushed silica is inexpensive, and can increase thermal conductivity of the insulating material. The crushed silica may be those crushed by two methods, a wet method and a dry method. FIG. 7 is a drawing schematically representing the first example of the additive material (dry crushed silica), and FIG. 8 is a drawing schematically representing the second example of the additive material (wet crushed silica). As shown in FIGS. 7 and 8, dry crushed silica 70 generally has less OH groups and residual water on the surface, and it is possible to avoid the adverse effect of water (such as curing inhibition and induction of side reactions) in the preparation of the resin. In addition, this effect helps the thermal conductivity of the resin to be increased.

On the surface of the wet crushed silica 71, more OH groups tend to be increased, in addition to attachment of H₂O and the like, and H₂O is likely to cause hydrogen bonding by the OH group to increase water on the surface. Water is exothermically bonded at the energy of 20 kJ/mol or more per one molecule (values obtained by molecular orbital calculation are shown in Table 1 below), and a drying process at 100° C. or more for one day and night is required for removing this water. In addition, the presence of water is likely to cause an undesirable effect on the polymerization of the epoxy resin. From this point, it is preferred to use dry crushed silica rather than wet crushed silica, as the crushed silica 1.

TABLE 1
Energy of water attachment (hydrogen bond)

| Number of attached | Hydrogen bond energy |
|---|---|
| water | (kJ/mol) |
| Before hydrating | 0 |
| Monohydrate | −20.9 |
| Dihydrate | −77.7 |
| Trihydrate | −107.6 |

The additive material (silica filler) may include fused silica (fused spherical silica) 2, as well as the crushed silica 1. The crushed silica can improve the thermal conductivity, but is likely to increase the coefficient of linear expansion, and may cause cracks in the case of being sealed by aluminum, ceramics, insulating paper, and the like, and thus, it is preferred to add fused silica to complement this. In addition, under an environment having a large temperature difference, residual thermal stress occurs in the resin, by the difference of the coefficient of linear expansion with other materials sealing the insulating material such as aluminum, ceramics or insulating paper. Here, this residual thermal stress can be decreased by the fused spherical silica 2 having a small coefficient of linear expansion, thereby improving crack resistance. In the present invention, since the added amount of the fine particles 4 as described above is 5% by mass or less to suppress increase of viscosity, other additive materials can be added.

In addition, the fused silica is fused spherical silica, thereby making the effect of reducing the coefficient of linear expansion isotropic, so that the dependency of the coefficient of linear expansion on a resin production direction is eliminated.

It is preferred that the content of the additive materials 1 and 2 is 0.1-70% by mass of the insulating material 10. When the content of the additive material is less than 0.1% by mass, the effect of the additive material cannot be sufficiently obtained. In addition, it is not preferred that the content is more than 70% by mass, since the viscosity is excessively increased. In addition, precipitation of the additive material cannot be sufficiently suppressed by the fine particles 4. It is preferred to determine the content of the additive material within the range of the content, considering the degrees of thermal conductivity and crack resistance to be imparted to the insulating material 10.

In addition to the above-described high thermal conductive material and the low linear expansion material, elastomer particles or a scaly additive material (filler) may be added within the above range of the content of the additive material. By improving the crack resistance of the resin, the fracture toughness of the resin is improved, thereby inhibiting crack progress. The elastomer is expected to greatly improve high toughness of the resin. For this, small elastomers are particularly preferred, and crack progress inhibiting action is expected by settling or increasing other number density. Likewise, the same action and effect can be expected also for the scaly filler (e.g., mica powder). In addition, polyoxyethylene, polyoxyethylene alkyl ether or polyoxyethylene phenyl ether may be contained at 1.5 parts by mass or less relative to 100 parts by mass of the additive material.

### (3) Resin

The resin 3 which is the matrix of the insulating material 10 is not particularly limited as long as it has a thermosetting property, and may include an epoxy-based resin, an unsaturated polyester resin, a polyphenol resin, a novolac resin, an ABS (acrylonitrile-styrene-butadiene copolymer) resin, a polyacetal resin and a composite thereof. When using the epoxy resin, the main skeleton of a prepolymer is preferably bisphenol A type 21.

The additive materials 1 and 2 and the fine particles 4 are mixed in the resin 3, and stirred for a sufficiently long time, so that the fine particles 4 are arranged around the additive materials 1 and 2, thereby obtaining the insulating materials 10 having the configuration represented by FIG. 1.

### [High Voltage Equipment]

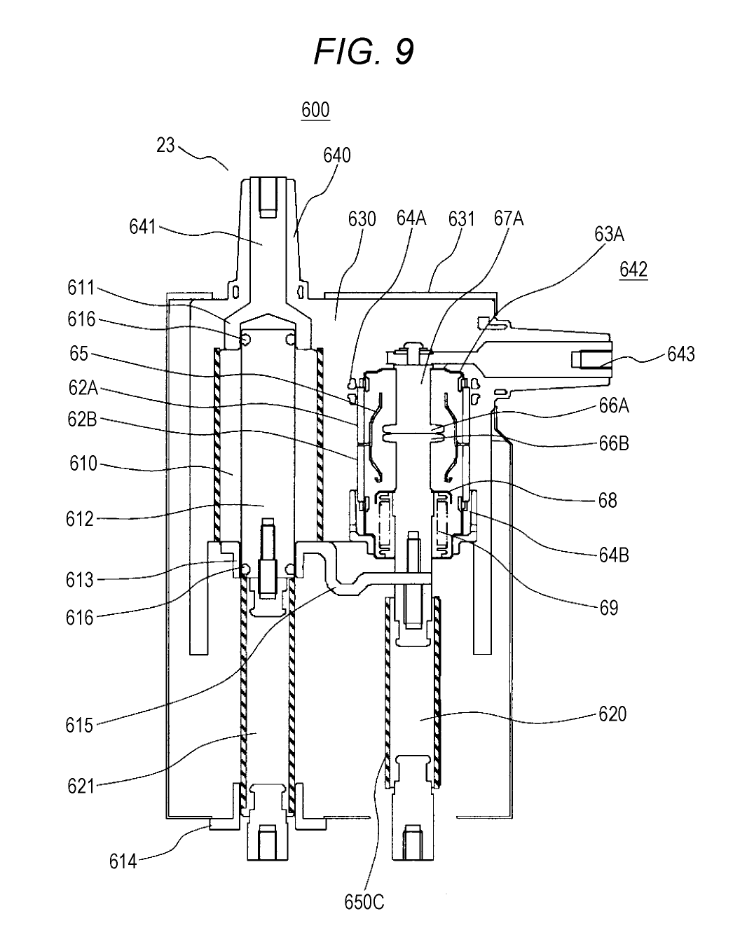

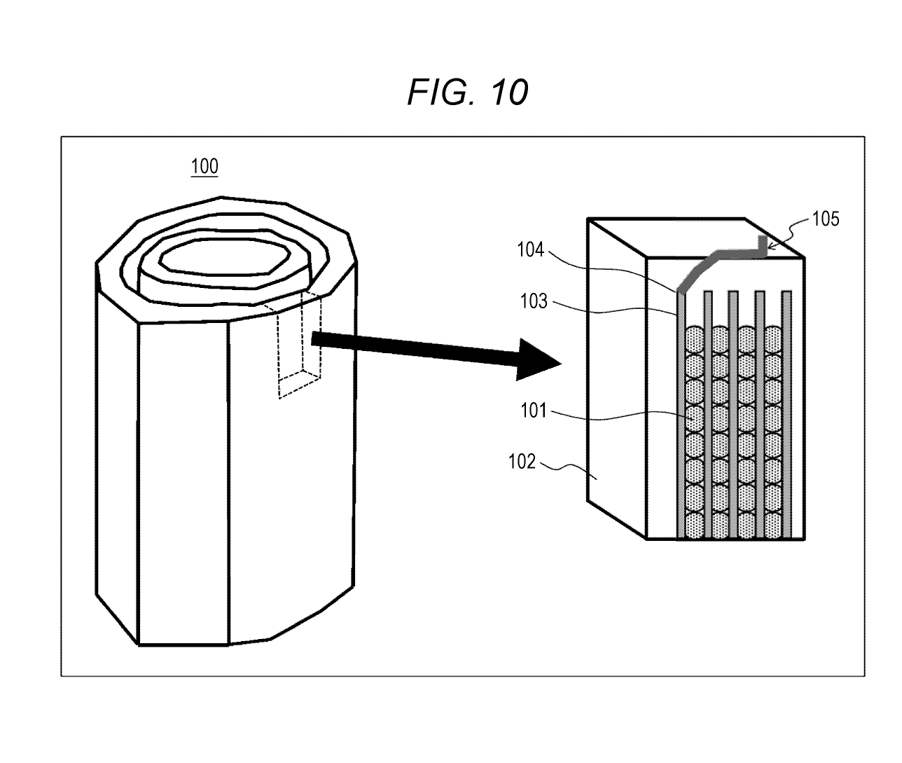

FIG. 9 is a schematic cross-sectional view representing a first example of the high voltage equipment (switch gear), and FIG. 10 is a schematic cross-sectional view representing a second example of the high voltage equipment (mold transformer). The insulating materials according to the present invention as described above are formed by molding, pressurizing or injection, and can be applied to the part where an insulation property of the high voltage equipment (receiving transformer equipment) is required. In general, in the mold transformer of FIG. 10, particularly the crack 105 easily occurs at the insulating paper end 104, however, the progress of cracks can be suppressed by using the insulating materials according to the present invention.

The high voltage equipment is not limited to the switch gear or the mold transformer, and can be applied to a generator, a converter, and the like. It can be applied to molding methods or products other than those described above. The insulating material according to the present invention can suppress precipitation of the additive material in the resin, while intending improved electrical properties and mechanical properties of the resin, and thus, high voltage equipment having high reliability can be obtained without the need to provide a heating facility.

### EXAMPLES

Insulating materials (sample Nos. 1-8) having various conditions were manufactured, and evaluated for precipitation amount of the additive material, and mechanical properties, electrical properties and viscosity of the insulating material. The results of evaluating the configuration and properties of the insulating materials are shown in the following Table 2. In Table 2, the average particle diameter of the fine particles was 200 nm, and the added amount was 5% by mass. In addition, the ratios of the organic group and the inorganic group forming the fine particles were 50%, respectively. The fracture toughness and the dielectric breakdown lifetime of the resin were evaluated by an impact test, and a V (voltage)−t (time) test, respectively. In addition, the viscosity was evaluated as “\textcircled{∘}” for “good”, “∘” as “somewhat good”, and “Δ” for “somewhat poor”, but all satisfies a practical level.

TABLE 2
Results of evaluating configuration and properties
of insulating materials of Samples 1-8

| | Configuration of insulating | | | | | | |
|---|---|---|---|---|---|---|---|
| | material | | | | | | |
| | Main | | | Results of evaluating properties | | | |
| | skeleton | | | | | Electrical | |
| | of | | | Precipitation | Mechanical | properties | |
| | additive | | | amount of | properties | Dielectric | |
| | material | Fine particles | | additive | Fracture | breakdown | |
| | and fine | Organic | Inorganic | material | toughness | lifetime | |
| Sample No. | particle | group | group | (a.u.) | (p.u.) | (p.u.) | Viscosity |
| Sample 1 | Silica | — | | 1 | 1 | 1 | ⊚ |
| Sample 2 | Silica | — | —OH | 0.5 | 1.2 | 1.5 | ◯ |
| Sample 3 | Silica | —CH₃ | — | 0.5 | 1.6 | 2.5 | Δ |
| Sample 4 | Silica | —CH₃ | —OH | 0.5 | 1.4 | 1.2 | ◯ |
| Sample 5 | Alumina | — | | 1 | 1 | 1 | ⊚ |
| Sample 6 | Alumina | — | —OH | 0.5 | 1.2 | 1.5 | ◯ |
| Sample 7 | Alumina | —CH₃ | — | 0.5 | 1.4 | 2 | Δ |
| Sample 8 | Alumina | —CH₃ | —OH | 0.5 | 1.2 | 1.9 | ◯ |

Samples including fine particles having no substituent (Sample Nos. 1 and 5) did not form a dendrite structure, since the fine particles were uniformly dispersed in the resin. Meanwhile, the sample including the fine particles having a substituent (Sample Nos. 2-4 and 6-8) formed a dendrite structure in the resin.

As shown in Table 2, the sample in which the skeleton of the additive material and the fine particles is silica (Sample Nos. 1-4), and also the sample in which the skeleton is alumina (Sample Nos. 5-8) had improved suppression of precipitation of the additive material, and improved mechanical and electrical properties, by adding the fine particles. The suppression of precipitation of the additive material is due to the fine particles being arranged around the additive material. In addition, in the case that the fine particles form a dendrite structure, the progress of cracks and electrical trees of the resin is suppressed, thereby more suppressing the progress of mechanical breakdown and electrical breakdown, than in the case that the fine particles are uniformly dispersed.

Samples in which the skeleton of the additive material and the fine particles is silica (sample Nos. 1-4), and also the samples in which the skeleton is alumina (sample Nos. 5-8) have the highest mechanical and electrical properties only when the fine particles have only the organic group (sample Nos. 3 and 7), however, the viscosity is unduly high. The sample in which the fine particles have the organic group and the inorganic group (sample Nos. 4 and 8) can have a balance between the mechanical and electrical properties, and the viscosity.

As described above, it was demonstrated that according to the present invention, an electrical insulating material for high voltage equipment which suppresses precipitation of additive materials, while achieving mechanical and electrical properties equal to or higher than those of the conventional materials can be provided.

Further, the above Examples are specifically described for facilitating understanding of the present invention. The present invention is not limited to having all of the configurations as described above. For example, it is possible to replace some of the configuration of one Example with the configuration of other Examples, and it is also possible to add the configuration of other Examples to the configuration of one Example. In addition, it is possible for some of the configuration of each Example to be deleted, replaced with other configuration, or add other configuration thereto.

### REFERENCE SIGNS LIST

1 additive material (high thermal conductive material)
2 additive material (low linear expansion material)
3 resin
4 fine particle
5 three-dimensional dendrite structure formed by fine particles 4
6 crack and electrical tree
10 insulation material
70 dry crushed silica
71 wet crushed silica
100 mold transformer
101 metal wire
102 resin (insulation material)
103 insulating paper
104 insulating paper end
105 crack
600 switch gear
61 vacuum valve
62A fixed side ceramics insulating tube
62B movable side ceramics insulating tube
63A fixed side end plate
63B movable side end plate
64A fixed side electric field relaxation shield
64B movable side electric field relaxation shield
65 arc shield
66A fixed side electrode
66B movable side electrode
67A fixed side holder
67B movable side holder
68 bellows shield
69 bellows
610 ground disconnector
611 ground disconnector bushing side fixed electrode
612 ground disconnector movable electrode
613 ground disconnector intermediate fixed electrode
614 ground disconnector ground side fixed electrode
615 flexible conductor
616 spring contact
617 connection conductor
620 operation rod for vacuum valve
621 operation rod for ground disconnector
630 solid insulator (resin)
631 metal container
640 bushing for bus bar
641 bushing center conductor for bus bar
642 bushing for cable
643 bushing center conductor for cable

1. An electrical insulating material for high voltage equipment comprising: a resin; and additive materials and fine particles dispersed in the resin,
wherein the fine particles have the same main skeleton as the additive materials, and have an average particle diameter of 1-200 nm, and some of atoms forming the main skeleton are bonded to an organic group and an inorganic group, and are arranged around the additive materials.

2. The electrical insulating material for high voltage equipment according to claim 1, wherein the main skeleton of the additive materials and the fine particles is formed of silica, alumina, boron nitride, aluminum nitride or a metal oxide, and some of silicon, aluminum, boron or metal atom forming the main skeleton is bonded to at least one of the organic group or the inorganic group.

3. The electrical insulating material for high voltage equipment according to claim 2, wherein the main skeleton of the additive materials and the fine particles is formed of silica, and a distance between silicon forming a surface of the additive materials and silicon forming the fine particles arranged around the additive materials is 0.9-1.1 nm.

4. The electrical insulating material for high voltage equipment according to claim 1, wherein the organic group is a hydrocarbon group having 2-5 carbon atoms.

5. The electrical insulating material for high voltage equipment according to claim 4, wherein the organic group is a methyl group or an ethyl group.

6. The electrical insulating material for high voltage equipment according to claim 1, wherein the inorganic group is a hydroxyl group, a boron nitride group or a silicon nitride group.

7. The electrical insulating material for high voltage equipment according to claim 1, wherein the fine particles form a dendrite structure in a form of being dispersed in the resin.

8. The electrical insulating material for high voltage equipment according to claim 1, wherein the additive material is a high thermal conductive material or a low linear expansion material.

9. The electrical insulating material for high voltage equipment according to claim 8, wherein the high thermal conductive material is crushed silica, and the low linear expansion material is fused spherical silica.

10. The electrical insulating material for high voltage equipment according to claim 1, further comprising: elastomer particles or a scaly additive material.

11. The electrical insulating material for high voltage equipment according to claim 1, further comprising: polyoxyethylene, polyoxyethylene alkyl ether or polyoxyethylene phenyl ether,
wherein these compounds are comprised at 1.5 parts by mass or less, relative to 100 parts by mass of the additive materials.

12. The electrical insulating material for high voltage equipment according to claim 1, wherein the resin is an epoxy-based thermosetting resin.

13. The electrical insulating material for high voltage equipment according to claim 1, wherein the electrical insulating material for high voltage equipment is an insulating material for a mold transformer, a switch gear or a generator.

14. The electrical insulating material for high voltage equipment according to claim 2, wherein the fine particles form a dendrite structure in a form of being dispersed in the resin.

15. The electrical insulating material for high voltage equipment according to claim 3, wherein the fine particles form a dendrite structure in a form of being dispersed in the resin.

16. The electrical insulating material for high voltage equipment according to claim 2, wherein the additive material is a high thermal conductive material or a low linear expansion material.

17. The insulating material for high voltage equipment according to claim 2, further comprising: elastomer particles or a scaly additive material.

18. The insulating material for high voltage equipment according to claim 2, further comprising: polyoxyethylene, polyoxyethylene alkyl ether or polyoxyethylene phenyl ether,
wherein these compounds are comprised at 1.5 parts by mass or less, relative to 100 parts by mass of the additive materials.

19. The insulating material for high voltage equipment according to claim 2, wherein the resin is an epoxy-based thermosetting resin.

20. The insulating material for high voltage equipment according to claim 2, wherein the electrical insulating material for high voltage equipment is an insulating material for a mold transformer, a switch gear or a generator.
